(19) United States
(12) Patent Application Publication
(10) Pub. No.: US 2025/0346293 A1
(43) Pub. Date: Nov. 13, 2025

(54) Booster With Pivoting Payload Portion

(71) Applicant: PREMIER COIL SOLUTIONS, INC., Waller, TX (US)

(72) Inventors: Randall Behrens, Sealy, TX (US); M. Brett Witte, Waller, TX (US)

(21) Appl. No.: 19/018,496

(22) Filed: Jan. 13, 2025

Related U.S. Application Data
(63) Continuation-in-part of application No. 17/881,429, filed on Aug. 4, 2022.
Application No. 17/881,429 is a continuation-in-part of application No. 16/292,904, filed on Mar. 5, 2019, now Pat. No. 11,654,981.
(60) Provisional application No. 62/638,380, filed on Mar. 5, 2018.
(60) Provisional application No. 63/619,917, filed on Jan. 11, 2024.

(51) Int. Cl. B62D 13/02; B62D 53/08

(52) U.S. Cl. CPC B62D 13/025; B62D 53/0864

(57) ABSTRACT

An auxiliary dolly is attachable to the rear of a primary trailer. The auxiliary dolly includes a first portion attachable to the primary trailer; a second portion comprising a chassis with one or more axles with wheels and a payload portion on the chassis. The payload portion is configured to pivot relative to the chassis with one or more axles with wheels of the second portion. A pivot point is at the point where the first portion is coupled to and movable relative to the second portion. Two or more cylinders are configured to pivot the payload portion of the second portion relative to the chassis with one or more axles with wheels of the second portion he pivot allows the payload portion to be substantially aligned with the primary trailer while turning.

### CROSS-REFERENCE TO RELATED APPLICATIONS

This application is a continuation-in-part of 17/881,429 filed Aug. 4, 2022 which is a continuation-in-part of Ser. No. 16/292,904 filed Mar. 5, 2019 and is now U.S. Pat. No. 11,654,981 which application claims priority to provisional application 62/638,380 filed Mar. 5, 2018. The application also claims priority to U.S. Provisional Application No. 63/229,395 which application is incorporated herein by reference. The application is also related to U.S. Provisional Application No. 63/229,395 and coil tubing patents which are U.S. Pat. Nos. 9,587,450; 9,828,026; 9,988,864 and U.S. Publication No. 20190270488, all of which are incorporated by reference herein.

This application also claims priority to U.S. provisional patent application filed Jan. 11, 2024 as Ser. No. 63/619,917 which application is incorporated herein by reference.

### FIELD

The present patent application relates to the application of delivery methods of coiled tubing equipment through the use of a booster assembly to transport, for example, injectors and/or other coiled tubing equipment.

### BACKGROUND AND SUMMARY

Premier Coil Solutions (PCS), 18993 GH Circle, Waller, Texas, USA, is an advanced manufacturer of Coiled Tubing Products. Premier Coil Solutions, herein known as PCS, is a worldwide leader in Engineering and Manufacturing Excellence in the Coiled Tubing Industry. Coiled Tubing is a relatively new technology for the oil and gas industry. It is used for interventions in oil and gas wells and production tubing. Previous to the introduction of Coil Tubing, Wirelining was used to complete similar operations. The most common application is deliquification, and the dispersement of fluids to a specific location in the well. Coiled Tubing equipment is commonly divided into categories on how it is transported to and from jobsites. Division of equipment can be based on Truck Mounted, Trailer Mounted or Skid Mounted equipment. Skid and trailer mounted equipment can be permanently affixed, or mounted in such a manner where it is removable from a trailer with little effort. Coiled Tubing equipment that is easily transported and serviceable offers owners the best return on their investment. Ideally, transporting coil tubing equipment efficiently decreases well service costs and reduces man-hours and jobsite injuries. Due to the depths of wells, the tubing footage needed to complete most well servicing jobs has increased, which in turn, the methods of transportation have been strained. Trailer lengths have been extended to offer more axles to allow more equipment or tubing to be transported to and from jobsites. By its' inherent nature, the equipment needed for operations is heavy and requires specially modified trailers designed to transport loads of extreme weight, height, length, and width. In some circumstances, highway and roadway weight restrictions require the use of additional axles or the use of equipment with several axles that mounts to either the front or rear of the trailer to ease the weight per axle ratio, therefore limiting the turning capability of trailers. What is needed are improved steering and suspension systems.

Advantageously, the present application pertains to an improved steering and suspension systems for coiling tubing and other equipment. In another embodiment, the present application pertains to an auxiliary dolly. In another embodiment the present application pertains to a booster for carrying payloads such as an injector for coiled tubing.

### BRIEF DESCRIPTION OF THE FIGURES

FIG. 1 shows hydraulic cylinders configured to create a pivoting motion on a rear booster section while a front section reacts against a trailer to transfer load from the rear trailer axles to the booster axles:
300—barrel or piston side of hydraulic cylinder;
310—rod side of hydraulic cylinder;
320—steering connection pin;
330—steering hydraulic cylinder;
340—forced applied to ground (combination of gravity and additional force from hydraulic cylinders;
350—pivoting horizontal hinge;
360—pinned attachment to trailer;
370—force applied to trailer.

FIG. 2 shows an auxiliary dolly embodiment.

FIG. 3 illustrates the booster attached to the powered tractor.

FIG. 4 illustrates the booster attached to a jeep.

FIG. 5 illustrates a booster assembly without a coiled tubing injector on the pivoting payload portion.

FIG. 6 illustrates a booster assembly with a coiled tubing injector on the pivoting payload portion.

FIG. 7 illustrates a top view of a booster assembly with a pivoting payload portion hidden to illustrate the hydraulic cylinders below.

FIG. 8 shows a bottom view of a booster assembly with a pivoting payload portion.

FIG. 9 shows a booster front iso view aligned with a payload.

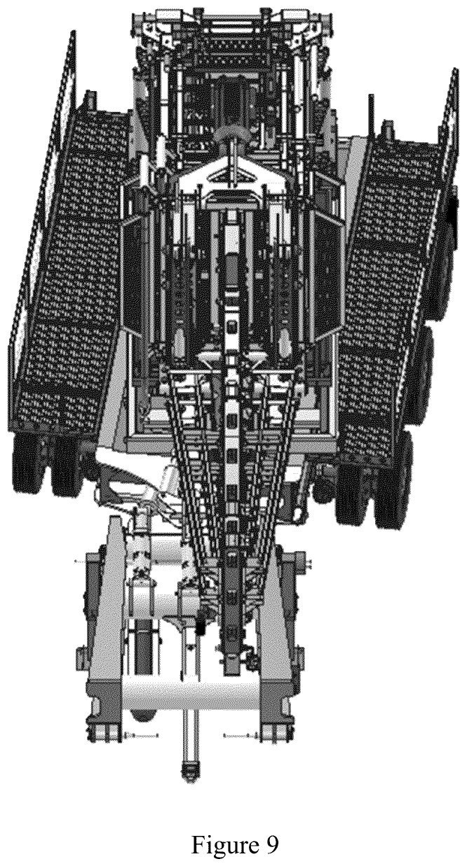

FIG. 10 shows booster front view aligned with a payload.

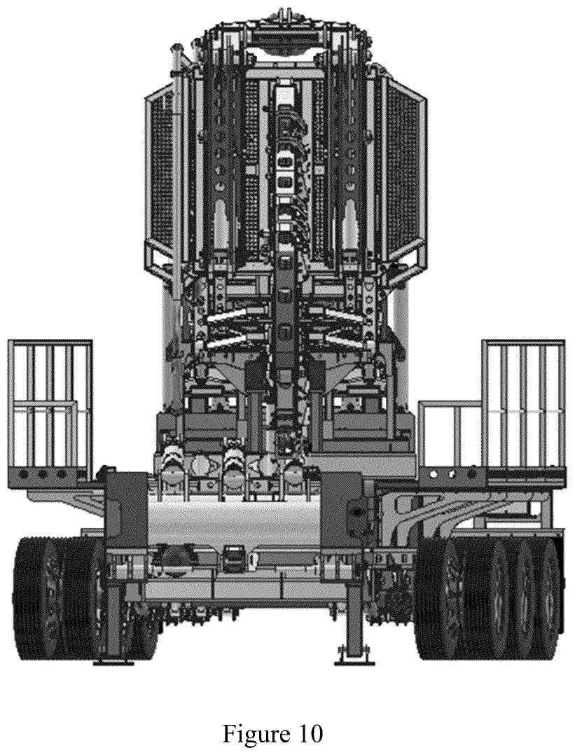

FIG. 11 shows a booster top view aligned without a payload.

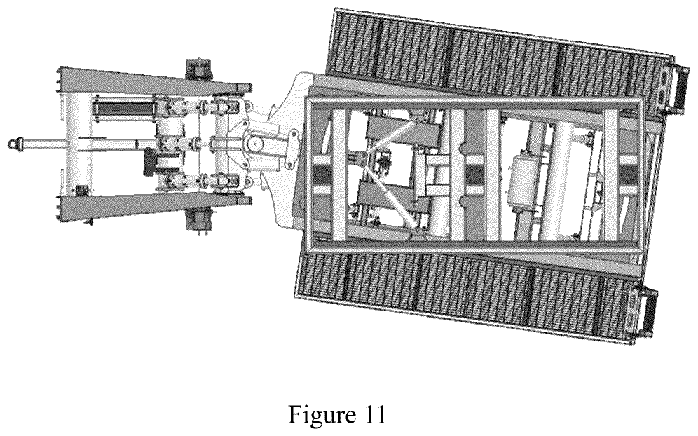

FIG. 12 shows a booster top view aligned with a payload.

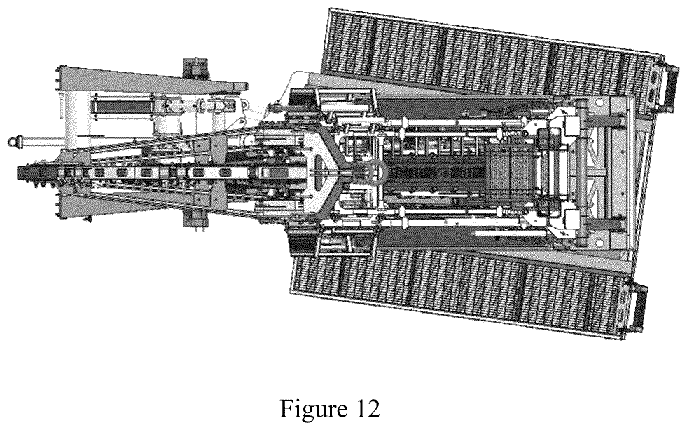

FIG. 13 shows cylinder reaction forces with the relative motion of the driving cylinders on the left portion and the driven cylinders on the right.

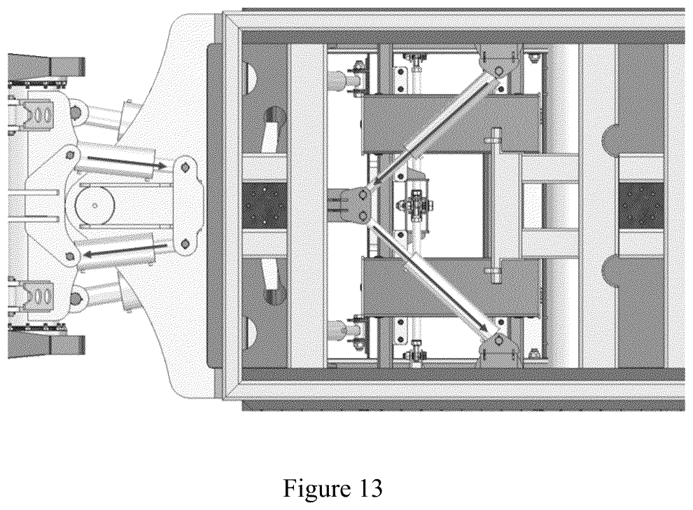

### DETAILED DESCRIPTION

### Steering Systems

This addresses the axle steering, and suspension system which allows for the increased maneuverability of a coil tubing unit involving the use of an integrated system to detect transportation conditions and adapt to scenarios in which the system can be preset by the transporter or driver to adapt to roadway conditions and loading scenarios, and to allow for expedited movements based on common scenarios in which field conditions require changes to the way a unit is transported due to restrictions based upon height, weight, steering radius, and other factors which present itself during transportation.

These pieces of equipment that are affixed to a trailer to decrease axle weight are a “jeep” which is mounted in-between the trailer and the tractor. The other piece is commonly known as a “Booster” is mounted to the rear of the trailer. To increase the turning capability of trailers, manufacturers started employing an axle or axles that will turn in the direction of the tractor and therefore allow the Tractor and Coiled Tubing Unit to turn at a decreased radius. Some axles are also able to be raised upon command to assist in distribution of weight.

The potential commercial value is limitless; as it pertains to significant design and safety advantages over our competition.

The Multi-Axle Load Balancing portion is designed to meet stringent over axle weight limitations on trailers that are designed in any multi-axle configuration. The layout contains a valve or valves or controllers that are operated by an electrical or hand operated switch or lever. It's also similar in that the controls the routing of air pressure from the air tanks and directs it towards the suspension and lift system for the lift axle. Where the system varies from normal design is during the lifting of any applicable axle, air pressure is increased to in one or more axles to offset weight. This is achieved by a proprietary designed control box and valves that are pneumatically powered, but also could be powered by hydraulic and electric or a combination thereof.

This system operates in a total of modes/configurations to meet requirements and or to assist in turning while under forward and or reverse movement. The embodiments described herein can be suited to fit any multi-axle trailer with hydraulic, air, or electric connections to the tractor, or pulling device, that may need to conform to highway laws by distributing axle weight, and steering maneuvers. These modes can be assisted by the additions of changes in movements to jeeps and boosters.

This application is directed towards the industry wide issues with safely and efficiently controlling the movement of a coil tubing unit within several scenarios in which the industry sees the most difficulty in transportation and assists in these to avoid equipment damage and decrease time between operations. Through the use of a basic cause and effect scenario the expected output of the system is controlled via the operator's actions. These scenarios are relevant on both highway and off-highway transportation based upon speed, weight, and axle steering. There is a limiting device which is also employed as a default safety measure to prevent unwanted scenario output based upon speed, weight, and axle steering or other input factors.

### Scenario #1—Highway Operation in Excess of a Preset Speed:

The operator can select the unit for highway operation which will allow for the trailer behind the tractor; either additionally equipped with or without a jeep and booster and a trailer or a combination of a jeep, trailer, no booster, or a trailer and booster with no jeep, to operate safely during roadway transportation. This scenario will allow the trailer to utilize a free float or drag steer for the turning axels of the trailer. This methodology resembles that of a normal shopping cart, whereas a combination of straight wheels and steering wheels are used after the direction is determined by the tractor steering.

Scenario #2-Highway/Off Road Operation Under of a Preset Speed:

The operator can select the unit for operation under a preset speed which will allow the unit to perform turning operations to prevent any restrictive equipment from interaction or damage due to small changes in direction that are common with low speed maneuvers with heavy haul scenarios. These small movements are present when trying to park or spot equipment in a close proximity or to maneuver around obstacles. Damage to the axles, trailer, jeep, and/or booster is most prevalent during these movements; due to the forces exhibited by essentially forcing movement to components that may not be designed or engineered to withstand intense forces. In this type of scenario, the booster is lifted from contact to the ground by hydraulic, electric, pneumatic, or other mechanical force. Next, a trailer axle is lifted from the ground, this can be any of the axles chosen by design. The remaining axles steer due to force. The turning force is regulated by either sensors on the 5th wheel of the trailer or regulated by other means.

Automatic choosing of scenarios 1 or 2 can be completed via choices made by the operator or declared by speed or other means in which a sensing unit predicts the scenario based on factors such as environment, speed, resistance, weight etc.

Scenarios 1 and 2 also contain a manual function in the event of failure of the system. These allow preset axles to turn and preset axles to follow. These actions for scenarios 1 and 2 may also be completed in reverse gears in any combination of steer and follow axles.

Scenario 3 is a Reverse only scenario in which engages all trailer axles straight and applies forces to keep them straight during all reverse movements, and lifts the axles of the booster to prevent any unexpected movement. This also employs the ability of the operator/driver to control the steering of the axles on the trailer towards any direction desired with actuation of buttons or valves to manually control the extent of the direction of the turn as well as independent axle groups or single axles at will.

All 3 scenarios benefit from certain forward and reverse movements. Failsafe scenarios are included to prevent any damage to the equipment. They are programmed to intervene as needed in any scenario or during transitions between scenarios. Additional trailer mounted equipment can be programmed to operate in when activated by a particular scenario. These additional equipment movements can be shifting of the reel along the axis of the trailer, and raising or lowering of the reel during low speed low clearance events. Other movements may include the automatic positioning of all axles manually or automatically depending on the direction of the turn.

As shown in FIG. 1 hydraulic cylinders may be configured to create a pivoting motion on a rear booster section while a front section reacts against a trailer to transfer load from rear trailer axles to booster axles. One or more cylinders are configured to adjust the first and second portions relative to each other and apportion weight between the primary trailer and the auxiliary dolly wherein the one or more cylinders comprise loading cylinders configured to apply and adjust vertical forces to apportion weight. As shown in FIG. 1 one way of making this adjustment is by employing a horizontal pivoting hinge. The rod end of the aforementioned hydraulic cylinder when extended pushes on one leg of the horizontal hinge which is connected to the rear portion of the booster. The piston or barrel end of the cylinder is attached to the front portion or fixed leg of the horizontal hinge and rotates the hinge thereby rotating the rear frame of the booster away from the front end of the booster creating additional force to the ground. The reaction force applied to the trailer frame rails creates an upward moment as shown in FIG. 1.

### Steering System Embodiments

1. A system comprising:
a multi-axle trailer with a front and a rear wherein the a multi-axle trailer comprises at least one lift axle configured to be raised or lowered to distribute weight, to increase trailer deflection during a turn, or both;
a tractor;
a jeep mounted between the trailer and tractor wherein the jeep is configured to decrease weight on one or more axles;
   a booster mounted to the rear of the multi-axle trailer;
wherein the system is configured such that during raising of the at least one lift axle an increase in air pressure to one or more other axles is increased to offset weight.

2. The system of embodiment 1 which further comprises a control box and one or more valves connected to one or more air tanks to increase the air pressure to the one or more other axles.

3. The system of embodiment 2 wherein the one or more valves are pneumatically powered.

4. The system of embodiment 2 wherein the one or more valves are hydraulic valves.

5. The system of embodiment 2 wherein the one or more valves are electric valves.

6. The system of embodiment 2 wherein the one or more valves are pneumatically powered, hydraulic, electric, or a combination thereof.

7. The system of embodiment 1 wherein the multi-axle trailer comprises a free float for turning axles.

8. The system of embodiment 1 wherein the multi-axle trailer comprises a drag steer for turning axles.

9. The system of embodiment 1 wherein the booster mounted to the rear of the multi-axle trailer is configured to be lifted and avoid contact with the ground via pneumatically powered, hydraulic, electric, or a combination thereof.

10. The system of embodiment 9 wherein the multi-axle trailer is configured such that any one or more axles may be lifted from the ground.

11. The system of embodiment 1 further comprising one or more sensors to regulate a turning force.

12. The system of embodiment 11 wherein the multi-axle trailer comprises a 5^{th} wheel and wherein the one or more sensors to regulate a turning force are on the 5^{th} wheel.

13. The system of embodiment 1 further comprising a control box operably linked to each of the axles on the multi-axle trailer wherein the control box and each of the axles on the multi-axle trailer are configured to allow a driver to independently control each axle.

14. The system of embodiment 13 wherein the control box is configured to allow a driver to manually control the extent of a direction of a turn.

### Auxiliary Dolly-Weight Adjustment

Embodiments disclosed herein relate to heavy-hauling trucking, coiled tubing units, and transportation of large components with the assistance of an auxiliary dolly or the need for an auxiliary dolly. An auxiliary dolly or “Booster” attaches to the rear of a primary trailer in order to offset weight from the primary trailer by adding axles to distribute heavy loads over more axles. In addition, the booster uses a fulcrum on the front end which applies an upwards or downwards force on the rear of the primary trailer to transfer weight to another auxiliary dolly or “Jeep” if affixed, which is located in-between the powered tractor and the primary trailer, or distributes directly to the powered tractor. The booster works in combination with any type of powered system, including but not limited to hydraulic, electric, pneumatic, or mechanical systems, which either partly or wholly steers the booster in succession with the primary trailer in response to the movement or actions of the tractor operator.

A reverse mode of the booster activates sensors that will articulate the rear frame of the booster through hydraulic, electric, pneumatic, or a mechanical system to straighten itself during reverse operation allowing the operator to reverse the entire unit as long as desired which aides in maneuvering the unit.

The booster utilizes a pivot point for turning one portion of the booster either horizontally or vertically or a combination thereof, that has wheels and tires affixed to one axle, two axles or three axles or more.

The booster may include a safety mechanism comprised of an adjustable sensing valve or sensor in which evaluates weight transfer from the primary trailer, and relieves and bleeds off the pressure of the booster as not to overload the booster axles, mechanical properties, or constructed materials and other parts of the booster, and or how much weight is applied and transferred to either the tractor, primary trailer, jeep or any component attached to the convoyed unit.

The booster may include a hydraulically powered suspension system in which to consume and transfer load, with or without the assistance of a secondary method which may be pneumatic, electric, hydraulic, or by mechanical means.

The booster may include an attached hitch, either female or male, mounted to either a permanently mounted or telescoping length of metal to allow it to be affixed to an accompanied opposite styled attachment method on a tractor or another auxiliary dolly or jeep for alternative transportation of the booster.

The booster may use pressurized or sensing equipment to measure weight applied or transferred on the booster.

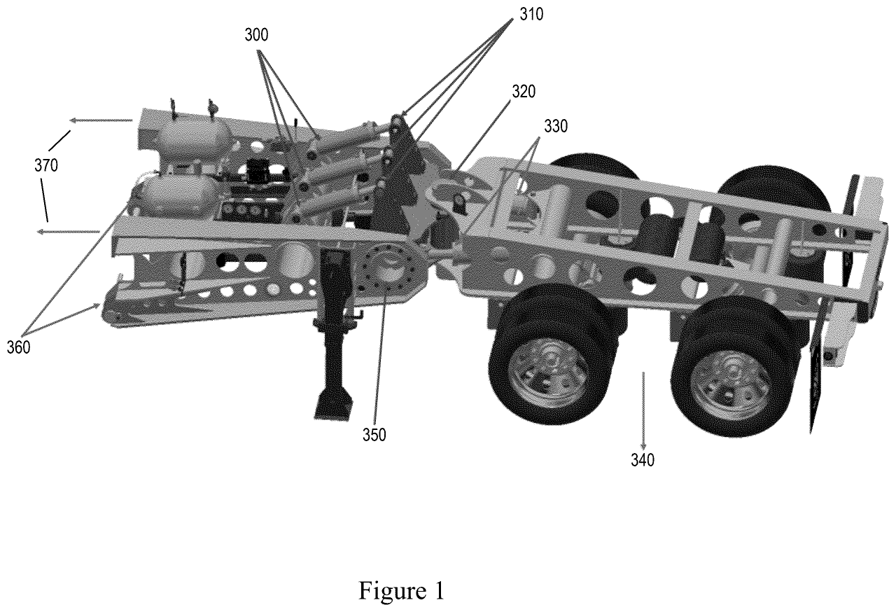

FIG. 2 illustrates one embodiment of a booster. The booster 100 is divided into two sections (first portion 100A and second portion 100 B) with a pivot point 109 at which the first and second potions can move relative to each other.

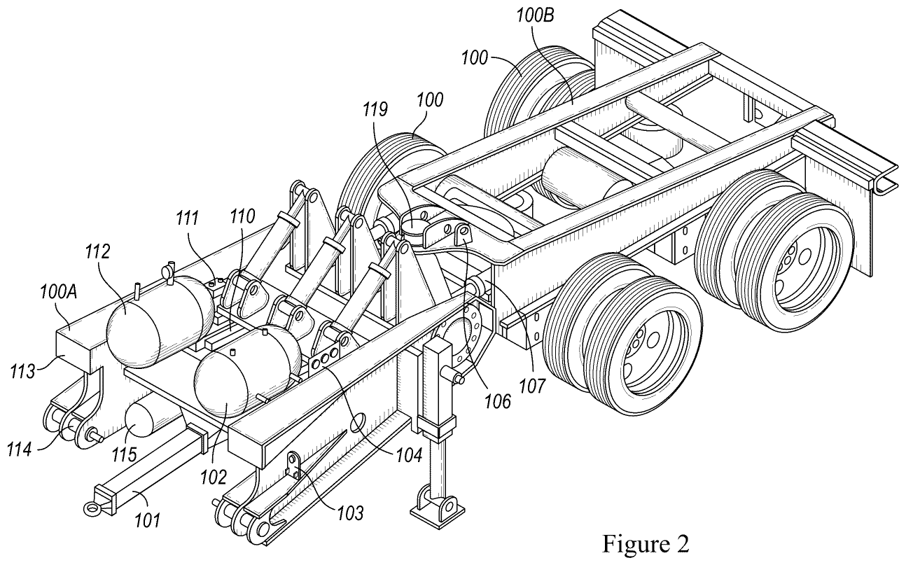

The first portion 100A of the booster may include a telescoping connection device 101 that allows it to be connected to a powered tractor with a corresponding mating connection, or a jeep 300 with a corresponding mating connection (FIG. 3). A hydraulic tank 102 provides hydraulic fluid for a bank of hydraulic cylinders 105 and steering cylinders 106. Power for the hydraulic loading cylinders 105 and steering cylinders 106 is made available through a 12V electrical connection on a bulkhead 103. The bulkhead 103 also has standard connections for emergency and tertiary braking systems, and electrical connections for signaling and braking lamps.

A booster monitoring panel 104 includes gauges to indicate system pressures, including dedicated gauges for piston side and rod side pressures for loading cylinders 105. The booster monitoring panel 104 also contains an activation valve which allows three methods of operation for the booster. A first method of operation allows the booster to run and operate as designed, i.e., apportioning or distributing weight between the primary trailer and the auxiliary dolly, a second method of operation allows it to completely “dump” the air and fluid from pneumatic and hydraulic systems, respectively, to allow detachment from the primary trailer, and finally a third method of operation allows it to lock the booster hydraulic system for alternate vehicle towing so that the booster remains level.

A valve (not shown) behind booster monitoring panel 104 is configured to cause the loading cylinders 105 to apply and adjust vertical forces, e.g., downward force or upward force, on the first portion 100A of the booster relative to the second portion 100B as the first portion 110A abuts against the primary trailer through flat surfaces 113. Another valve (not shown) below booster monitoring panel 104 is configured to set the rod side back pressure for loading cylinders 105 for cylinder stability, i.e., restricts further adjustments of loading cylinders 105 and holds the cylinder rods in place. The valve that adjusts the downforce applied by the loading cylinders 105 may also relieve excess pressure for overload protection on the hydraulic system and the interfacing mechanical surfaces. This may be used as failsafe for the system to prevent unit damage from high load fluctuations due to height differences between the primary trailer and the booster when traveling over uneven road conditions.

Air is provided by a 12V air pump 110, and override controls 111 are present to straighten the rear of the booster 100B if the need arises, or failure of the electrical system or connections 103. An accumulator 116 is present to aid in providing the hydraulic system instant pressure so that the cylinders react quickly and smoothly. Below the straightening valve 111 is a lockout valve for towing 112. The lockout valve 112 may be actuated during towing by tractor and towing by a jeep. The lockout valve 112 locks the steering to a straight travel only position.

The second portion 100B of the booster may have one, two, or three or more axles which apply weight by the use of standard industry suspension methods. This weight is distributed to and among the axles 108. The booster 100 may include standard air tanks (not shown) to store pneumatic pressure for use in the braking systems for axles 108. The second portion 100B further includes dual or paired hydraulic cylinders located on opposite sides to provide hydraulic pressure to steer the second portion 100B in either direction using pivot point 109 as a fulcrum to pivot from the first portion 100A.

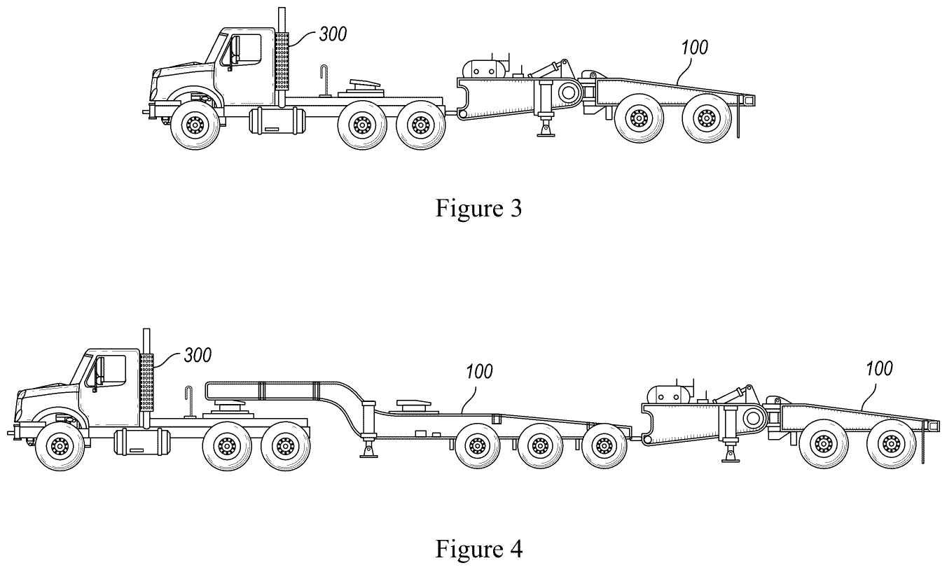

FIG. 3 illustrates the booster 100 attached to the powered tractor 200, using a pintle style male and female hooking system, or any other hooking system that will allow connection. FIG. 4 illustrates the booster 100 attached to a jeep 300, using a pintle style male and female hooking system, or any other hooking system that will allow connection which is towed by a powered tractor 200.

### Auxiliary Dolly Weight Adjustment Embodiments

1. An auxiliary dolly attachable to the rear of a primary trailer, the auxiliary dolly comprising:
a first portion attachable to the primary trailer, a second portion comprising one or more axles with wheels, and a pivot point at which the first portion is coupled to and movable relative to the second portion; and
one or more cylinders configured to adjust the first and second portions relative to each other and apportion weight between the primary trailer and the auxiliary dolly wherein the one or more cylinders comprise loading cylinders configured to apply and adjust vertical forces to apportion weight; and
a sensor that monitors weight being apportioned between the primary trailer and the auxiliary dolly, wherein upon sensing excess weight being applied to either the primary trailer or the auxiliary dolly, the sensor causes the one or more cylinders to adjust the first and second portions of the auxiliary dolly relative to each other and thereby reapportion weight between the primary trailer and the auxiliary dolly.

2. The auxiliary dolly of embodiment 1, wherein the one or more cylinders comprise loading cylinders configured to apply and adjust vertical forces on the first portion of the auxiliary dolly.

3. The auxiliary dolly of embodiment 1, wherein the one or more cylinders comprise steering cylinders configured to turn the first and second portions relative to each other.

4. The auxiliary dolly of embodiment 1, further comprising a connection device configured to couple the first portion of the auxiliary dolly to a powered tractor.

5. An auxiliary dolly attachable to the rear of a primary trailer, the auxiliary dolly comprising:
a first portion flexibly coupled to a second portion comprising one or more axles with wheels, wherein the first and second portions are flexible relative to each other, and wherein based on a feedback that excess weight is being applied to either the primary trailer or the auxiliary dolly, the first and second portions are adjustable relative to each other to reapportion weight between the primary trailer and the auxiliary dolly; and
a sensor that monitors weight being apportioned between the primary trailer and the auxiliary dolly, wherein upon sensing excess weight being applied to either the primary trailer or the auxiliary dolly, the sensor causes loading cylinders to adjust relative vertical forces between the first and second portions relative to each other and thereby reapportion weight between the primary trailer and the auxiliary dolly.

6. The auxiliary dolly of embodiment 5, wherein the loading cylinders are coupled between the first and second portions.

7. An auxiliary dolly attachable to the rear of a primary trailer, the auxiliary dolly comprising:
a first portion attachable to the primary trailer, a second portion comprising one or more axles with wheels, and a pivot point at which the first portion is coupled to and movable relative to the second portion; and
one or more cylinders configured to adjust the first and second portions relative to each other and apportion weight between the primary trailer and the auxiliary dolly wherein the one or more cylinders comprise loading cylinders configured to apply and adjust vertical forces to apportion weight; and
a steering system configured to straighten the second portion relative to the first portion when the auxiliary dolly is moved in reverse.

8. The auxiliary dolly of embodiment 7, wherein the one or more cylinders comprise loading cylinders configured to apply and adjust vertical forces on the first portion of the auxiliary dolly.

9. The auxiliary dolly of embodiment 7, wherein the one or more cylinders comprise steering cylinders configured to turn the first and second portions relative to each other.

10. The auxiliary dolly of embodiment 7, further comprising a connection device configured to couple the first portion of the auxiliary dolly to a powered tractor.

11. An auxiliary dolly attachable to the rear of a primary trailer, the auxiliary dolly comprising:
a first portion attachable to the primary trailer, a second portion comprising one or more axles with wheels, and a pivot point at which the first portion is coupled to and movable relative to the second portion; and
one or more cylinders configured to adjust the first and second portions relative to each other and apportion weight between the primary trailer and the auxiliary dolly; and
a sensor that monitors weight being apportioned between the primary trailer and the auxiliary dolly, wherein upon sensing excess weight being applied to either the primary trailer or the auxiliary dolly, the sensor causes the one or more cylinders to adjust the first and second portions of the auxiliary dolly relative to each other and thereby reapportion weight between the primary trailer and the auxiliary dolly;
wherein the one or more cylinders comprise loading cylinders and steering cylinders.

### Booster With Pivoting Payload Portion

It should be understood that embodiments of the steering systems and the auxiliary dolly weight adjustment described above may be employed in combination with the booster with pivoting payload portion described in this section. The booster described herein may be employed to attach to a primary trailer to balance the load. The booster may steer while turning which is advantageous to lessen wear and damage on tires, wheels, and/or axles, e.g., reduced “tire scrubbing”. Such wear and damage may be caused by a high induced side load due to, for example, a turn. The boosters described here facilitate keeping the booster payload in substantial alignment with the trailer.

The boosters here may also facilitate advantageous axle loading to meet local permitting requirements. That is, a pivoting payload portion as described here may facilitate alignment with the primary or main trailer even when float steering. The pivoting payload portion is configured such that it moves in the opposite direction from the steer direction thereby maintaining the payload in substantial alignment with the primary trailer. While the booster may be used for many applications it is particularly useful in coil tubing applications where an injector may be the payload on the booster while allowing the primary trailer to carry larger amounts of coiled tubing than capable in conventional systems. For example, in some embodiments a down force on the booster takes load of the rear axles which may allow a split of the weight between the kingpin and booster axles thereby facilitating additional potential payload on the trailer.

Generally, the auxiliary dolly, i.e., booster, is configured such that it may be attachable to the rear of a primary trailer but it may be useful when attached to a powered tactor as well. The auxiliary dolly comprises two or more portions. A first portion is attachable to the primary trailer or other powered or unpowered vehicle. A second portion typically comprises a chassis with one or more axles with wheels and a payload portion on the chassis. There is often a pivot point at which the first portion is coupled to and movable relative to the second portion. Advantageously, the payload portion is configured to pivot relative to the chassis with one or more axles with wheels of the second portion.

Two or more cylinders may be configured to pivot the payload portion of the second portion relative to the chassis with one or more axles with wheels of the second portion. The pivot advantageously allows the payload portion to be substantially aligned with the primary trailer while turning. This lessens wear and damage on tires, wheels, and/or axles, e.g., reduced “tire scrubbing” due to, for example, high induced side loads during a turn.

In some embodiments, there may be a sensor that monitors steering. The sensor may be configured such that when it senses a turn it causes the booster system to pivot the payload portion of the second portion relative to the chassis with one or more axles with wheels of the second portion. The pivot is such that the payload portion is substantially aligned with the primary trailer during and/or after the turn.

The system may be configured in any convenient manner to accomplish the pivot of the aforementioned payload portion during a turn. In some embodiments, hydraulic cylinders may be employed. For example, there may be two or more cylinders comprising driving cylinders in the first portion fluidly connected to two or more driven cylinders in the second portion. The cylinders may be configured or arranged in a convenient manner such that fluid is automatically transferred to the driven cylinders when turning in order to pivot the payload portion to a desired position. The configuration or arrangement of the cylinders may vary but it may be advantageous to employ a cross-connection to facilitate automatic fluid transfer during turning. That is, the power to move the hydraulic fluid in the cylinders may be supplied by any convenient source including being self-powered.

In some embodiments, the desired position of the payload portion is one in which side loading is not substantially induced during a turn and/or wherein the payload portion remains substantially aligned with the vehicle in front of the booster, e.g., primary trailer. The amount of the pivot of the payload portion may be adjusted to any desired angle. A desired angle may vary depending upon the configuration of the system, weight, number and type of tires and axles, etc.

However, in some embodiments the payload portion may be configured to pivot to approximately one half of the angle of the turn.

As described above, if desired embodiments of the weight adjustment and steering systems may be employed with the booster having a pivoting payload. Non-limiting combinations of the various embodiments are described in the below section called “Booster with Pivoting Payload Embodiments”.

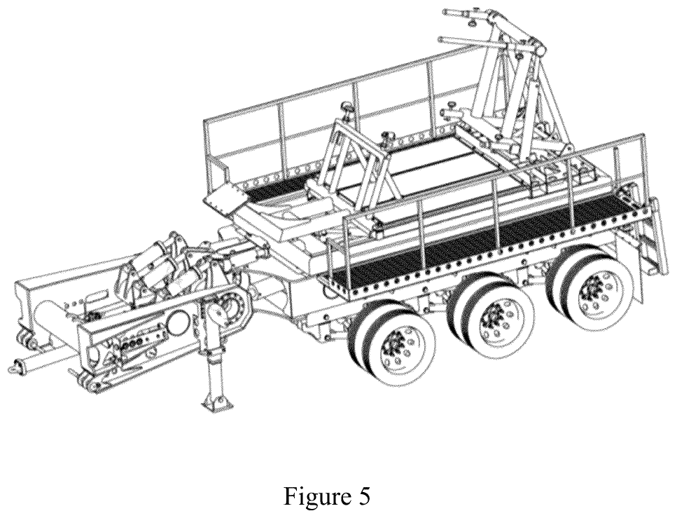

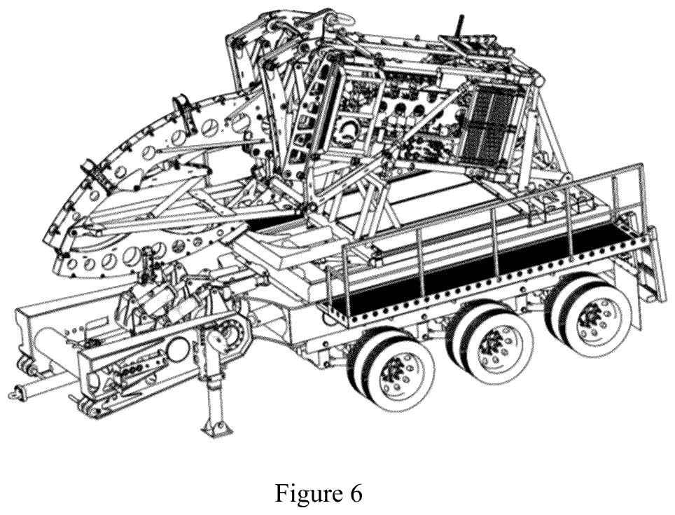

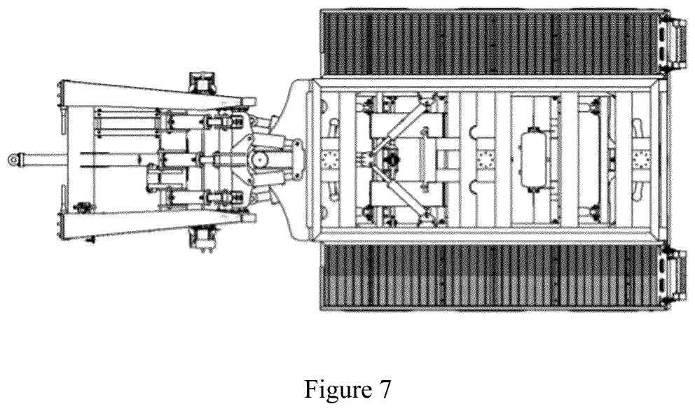

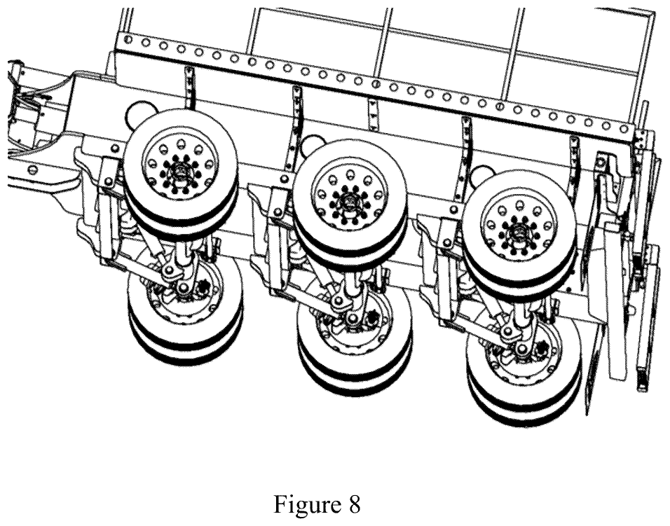

Representative embodiments of the booster having a pivoting payload are shown in FIGS. 5-8. FIG. 5 illustrates a booster assembly without a coiled tubing injector on the pivoting payload portion with handrails atop a chassis while FIG. 6 illustrates a booster assembly with a coiled tubing injector on the pivoting payload portion. Of course, a payload other than injector may be transported. The pivoting payload portion may be in any desired shape. As shown in FIG. 6 the pivoting payload portion may be shaped like a substantially rectangular table that is in a substantially horizontal plane. The pivoting payload table may be attached to the chassis so that it rotates in a clockwise or counterclockwise motion in the same horizontal plane so as to maintain the relative payload alignment with the primary trailer. FIG. 7 illustrates a top view of a booster assembly with a pivoting payload portion hidden to illustrate the hydraulic cylinders below. The driving and driven hydraulic cylinders described above are shown between the chassis pivoting payload portion but is should be understood that the hydraulic cylinders may instead be pneumatic or other actuators. It should also be understood that the actuators may be located elsewhere so long as they are configured to move the pivoting payload portion as desired to substantially align the payload with the primary trailer. FIG. 8 shows a bottom view of a booster assembly with a pivoting payload portion. As FIG. 8 shows, the second portion may comprises hydraulic suspension.

Booster with Pivoting Payload Embodiments

1. An auxiliary dolly attachable to the rear of a primary trailer, the auxiliary dolly comprising:
a first portion attachable to the primary trailer;
a second portion comprising a chassis with one or more axles with wheels and a payload portion on the chassis wherein the payload portion is configured to pivot relative to the chassis with one or more axles with wheels of the second portion;
a pivot point at which the first portion is coupled to and movable relative to the second portion; and
two or more cylinders configured to pivot the payload portion of the second portion relative to the chassis with one or more axles with wheels of the second portion and wherein the pivot allows the payload portion to be substantially aligned with the primary trailer while turning.

2. The auxiliary dolly of embodiment 1 further comprising a sensor that monitors steering, wherein upon sensing a turn, the sensor causes the two or more cylinders to pivot the payload portion of the second portion relative to the chassis with one or more axles with wheels of the second portion such that the payload portion is substantially aligned with the primary trailer while turning.

3. The auxiliary dolly of embodiment 1 further comprising one or more cylinders configured to apportion weight between the primary trailer and the auxiliary dolly, wherein the one or more cylinders comprise loading cylinders configured to apply and adjust vertical forces to apportion weight between the primary trailer and the auxiliary dolly.

4. The auxiliary dolly of embodiment 1 wherein the two or more cylinders comprise driving cylinders in the first portion and driven cylinders in the second portion, wherein the driving cylinders and driven cylinders are fluidly connected, and wherein the driven cylinders are configured to transfer fluid to the driven cylinders and pivot the payload portion when turning.

5. The auxiliary dolly of embodiment 4 wherein the driving cylinders and driven cylinders are in a cross connection orientation.

6. The auxiliary dolly of embodiment 1 further comprising a coiled tubing injector on the payload portion.

7. The auxiliary dolly of embodiment 1 wherein while turning the payload portion is configured to pivot to approximately one half of the angle of the turn.

8. The auxiliary dolly of embodiment 1 wherein the second portion is self-powered.

9. The auxiliary dolly of embodiment 3, wherein the one or more cylinders comprise loading cylinders configured to apply and adjust vertical forces on the first portion of the auxiliary dolly.

10. The auxiliary dolly of embodiment 1, further comprising one or more steering cylinders configured to turn the first and second portions relative to each other.

11. The auxiliary dolly of embodiment 1, further comprising a connection device configured to couple the first portion of the auxiliary dolly to a powered tractor.

12. The auxiliary dolly of embodiment 1, wherein based on a feedback that excess weight is being applied to either the primary trailer or the auxiliary dolly, the first and second portions are adjustable relative to each other to reapportion weight between the primary trailer and the auxiliary dolly.

13. auxiliary dolly of embodiment 12 wherein loading cylinders adjust relative vertical forces between the first and second portions relative to each other to reapportion weight between the primary trailer and the auxiliary dolly.

14. The auxiliary dolly of embodiment 14, wherein the loading cylinders are coupled between the first and second portions.

15. The auxiliary dolly of embodiment 1 further comprising a steering system configured to straighten the second portion relative to the first portion when the auxiliary dolly is moved in reverse.

16. The auxiliary dolly of embodiment 1 further comprising a steering system configured to turn the first and second portions relative to each other.

17. The auxiliary dolly of embodiment 1 further comprising one or more cylinders configured to adjust the first and second portions relative to each other and apportion weight between the primary trailer and the auxiliary dolly; and
a sensor that monitors weight being apportioned between the primary trailer and the auxiliary dolly, wherein upon sensing excess weight being applied to either the primary trailer or the auxiliary dolly, the sensor causes the one or more cylinders to adjust the first and second portions of the auxiliary dolly relative to each other and thereby reapportion weight between the primary trailer and the auxiliary dolly;
wherein the one or more cylinders comprise loading cylinders and steering cylinders.

What is claimed is:

1. An auxiliary dolly attachable to the rear of a primary trailer, the auxiliary dolly comprising:
a first portion attachable to the primary trailer;
a second portion comprising a chassis with one or more axles with wheels and a payload portion on the chassis wherein the payload portion is configured to pivot relative to the chassis with one or more axles with wheels of the second portion;
a pivot point at which the first portion is coupled to and movable relative to the second portion; and
two or more cylinders configured to pivot the payload portion of the second portion relative to the chassis with one or more axles with wheels of the second portion and wherein the pivot allows the payload portion to be substantially aligned with the primary trailer while turning.

2. The auxiliary dolly of claim 1 further comprising a sensor that monitors steering, wherein upon sensing a turn, the sensor causes the two or more cylinders to pivot the payload portion of the second portion relative to the chassis with one or more axles with wheels of the second portion such that the payload portion is substantially aligned with the primary trailer while turning.

3. The auxiliary dolly of claim 1 further comprising one or more cylinders configured to apportion weight between the primary trailer and the auxiliary dolly, wherein the one or more cylinders comprise loading cylinders configured to apply and adjust vertical forces to apportion weight between the primary trailer and the auxiliary dolly.

4. The auxiliary dolly of claim 1 wherein the two or more cylinders comprise driving cylinders in the first portion and driven cylinders in the second portion, wherein the driving cylinders and driven cylinders are fluidly connected, and wherein the driven cylinders are configured to transfer fluid to the driven cylinders and pivot the payload portion when turning.

5. The auxiliary dolly of claim 4 wherein the driving cylinders and driven cylinders are in a cross connection orientation.

6. The auxiliary dolly of claim 1 further comprising a coiled tubing injector on the payload portion.

7. The auxiliary dolly of claim 1 wherein while turning the payload portion is configured to pivot to approximately one half of the angle of the turn.

8. The auxiliary dolly of claim 1 wherein the second portion is self-powered.

9. The auxiliary dolly of claim 3, wherein the one or more cylinders comprise loading cylinders configured to apply and adjust vertical forces on the first portion of the auxiliary dolly.

10. The auxiliary dolly of claim 1, further comprising one or more steering cylinders configured to turn the first and second portions relative to each other.

11. The auxiliary dolly of claim 1, further comprising a connection device configured to couple the first portion of the auxiliary dolly to a powered tractor.

12. The auxiliary dolly of claim 1, wherein based on a feedback that excess weight is being applied to either the primary trailer or the auxiliary dolly, the first and second portions are adjustable relative to each other to reapportion weight between the primary trailer and the auxiliary dolly.

13. auxiliary dolly of claim 12 wherein loading cylinders adjust relative vertical forces between the first and second portions relative to each other to reapportion weight between the primary trailer and the auxiliary dolly.

14. The auxiliary dolly of claim 14, wherein the loading cylinders are coupled between the first and second portions.

15. The auxiliary dolly of claim 1 further comprising a steering system configured to straighten the second portion relative to the first portion when the auxiliary dolly is moved in reverse.

16. The auxiliary dolly of claim 1 further comprising a steering system configured to turn the first and second portions relative to each other.

17. The auxiliary dolly of claim 1 further comprising one or more cylinders configured to adjust the first and second portions relative to each other and apportion weight between the primary trailer and the auxiliary dolly; and
a sensor that monitors weight being apportioned between the primary trailer and the auxiliary dolly, wherein upon sensing excess weight being applied to either the primary trailer or the auxiliary dolly, the sensor causes the one or more cylinders to adjust the first and second portions of the auxiliary dolly relative to each other and thereby reapportion weight between the primary trailer and the auxiliary dolly;
wherein the one or more cylinders comprise loading cylinders and steering cylinders.

18. The auxiliary dolly of claim 1 wherein the pivoting payload portion is a substantially rectangular table that is configured to rotate clockwise or counterclockwise in a horizontal plane.
